(19) United States
(12) Patent Application Publication
(10) Pub. No.: US 2004/0002421 A1
(43) Pub. Date: Jan. 1, 2004

(54) Method for manufacturing catalytic stuff and catalytic stuff

(76) Inventors: Tsuneo Nihei, Aizuwakamatsu-shi (JP); Noriko Nihei, Aizuwakamatsu-shi (JP)

Correspondence Address: Tsuneo Nihei, 763 Shimoamaya, Otomachi, Aizuwakamatsu-shi, Fukushima, 969-5112, JP

(21) Appl. No.: 10/183,171

(22) Filed: Jun. 28, 2002

(51) Int. Cl. B01J 21/18

(52) U.S. Cl. 502/174; 502/182; 502/183; 502/184

(57) ABSTRACT

A method for manufacturing a catalytic stuff includes grinding the ore containing silica as main component, carbon, etc.; burning the powder object at high temperature after grinded the ore; emitting the carbon dioxide generated by combustion and churning of other substances which are sticking to silica during combustion of the powder object; and burning the remained catalytic stuff at high temperature again after carbon dioxide emits and manufacturing the catalytic stuff used for the mixed material with metal, filter medium of pollution water, propagation material etc. so that the tap water, the polluted water are improved efficient using the generated catalytic stuff, and it can be used broadly as water for home use, industrial use, agricultural use, and medical treatment, etc. and the balance of the body and cell can improve remarkably by holding the catalytic stuff since the generated catalytic stuff has the ultra-red ray effect etc.

### BACKGROUND OF THE INVENTION

The present invention relates to a method for manufacturing a catalytic stuff and the catalytic stuff.

The conventional reaction of mixture of the ore which makes the main ingredients the grounded silica and carbon is generated into the graphite crucible furnace, the graphite crucible furnace is reacted without making the carbon dioxide. After that, carbon monoxide (CO) is generated. Then the lid or cover is used in order to promote a reaction.

The conventional manufacturing method is to confine and generate the gas which occurs at the time of combustion so that it need a large-scaled equipment and cost greatly. Also the ultra-red ray effect which graphite silica has could not fully be pulled out.

### SUMMARY OF HE INVENTION

Accordingly, it is an object of the present invention to provide the to a method for manufacturing a catalytic stuff and the catalytic stuff that the catalytic stuff which and generated after discharged gas after the powder of graphite silica is burned is used to purify tap water, the polluted water efficiently, and such treated water is used for water for home use, water for industrial use, water for agricultural use, and medical treatment broadly. It is anther object of the present invention to provide the to a method for manufacturing a catalytic stuff and the catalytic stuff that the balance of the whole body is improved by the ultra-red ray effect etc. effectively.

The novel features which are believed to be characteristic of the invention, both as to its organization and method of operation, together with further objects and advantages thereof, are described below with reference to the accompanying drawings in which a presently preferred embodiment of the invention is illustrated as an example.

It is to be expressly understood, however, that the drawings are for the purpose of illustration and description only, and are not intended as a definition of the limits of the invention.

### BRIEF DESCRIPTION OF THE DRAWINGS

FIG. 1 is a flow of a manufacturing showing a first embodiment of the present invention;

FIG. 2 is an explanation view of a pulverization process showing a first embodiment of the present invention;

FIG. 3 is an explanation view of a combustion process showing a first embodiment of the present invention;

FIG. 4 is an explanation view of an emission process showing a first embodiment of the present invention;

FIG. 5 is an explanation view of a re-combustion process showing a first embodiment of the present invention;

FIG. 6 is a reference view when in use showing a first embodiment of the present invention;

FIG. 7 a flow of a manufacturing showing a second embodiment of the present invention;

FIG. 8 an explanation view of a catalytic process showing a first embodiment of the present invention;

FIG. 9 is a reference view when in use showing a second embodiment of the present invention;

FIG. 10 a flow of a manufacturing showing a third embodiment of the present invention;

FIG. 11 an explanation view of a forming process showing a first embodiment of the present invention;

FIG. 12 is a reference view when in use showing a third embodiment of the present invention; and

FIG. 13 is a reference view when in use showing a third embodiment of the present invention.

### DETAILED DESCRIPTION OF THE PREFERRED EMBODIMENTS

Preferred embodiments of the present invention are described in more detail below referring to the accompanying drawings.

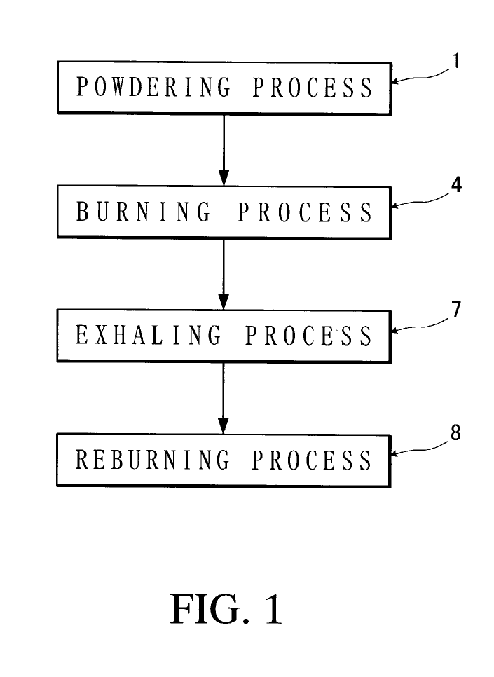

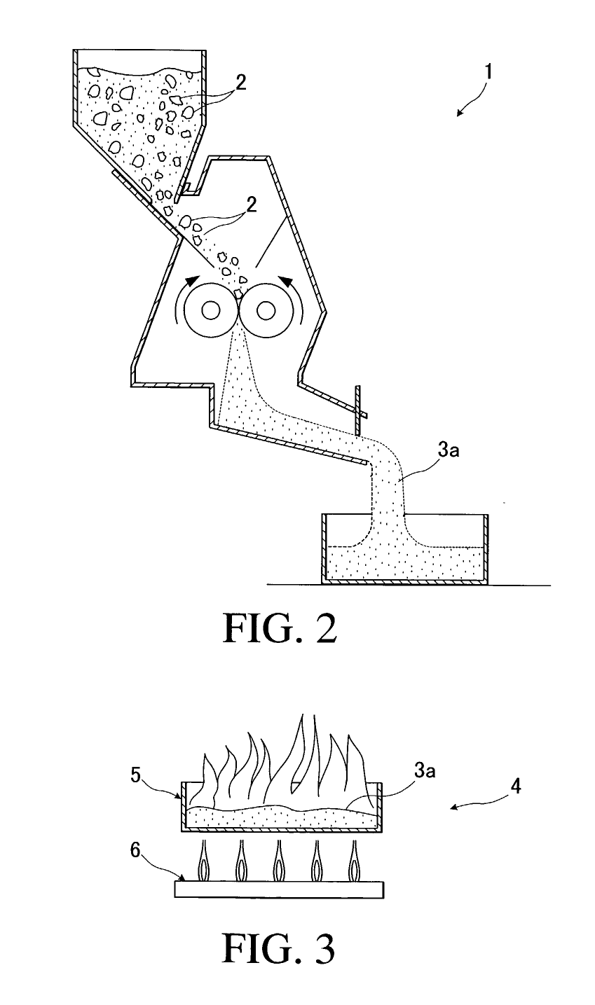

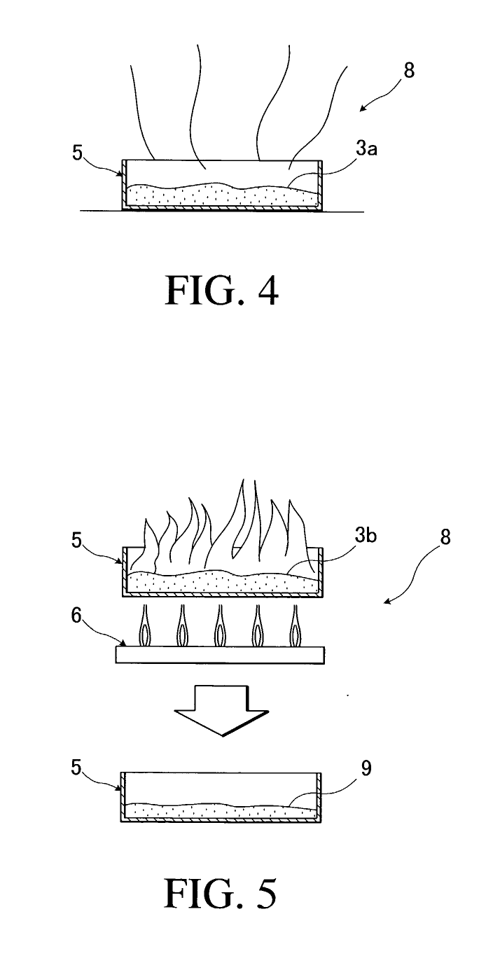

An understanding of the present invention may be best gained by reference FIGS. 1 to 6. In the first embodiment of the present invention illustrated in FIGS. 1 to 6, the numeral 1 shows a pulverization process which grinds an ore 2. The ore 2 containing silica as main component is used for materials at this pulverization process 1. The ore 2 includes an ingredient as industrial materials and composites so that you may call it the natural ore for generation of silicon carbide whisker without alumina as one of components. The ore 2 is ground in the range with a particle size of 10 to 50 micrometers, and a powder object 3a is generated.

In addition, although it is more desirable for the particle size to have gathered, it does not require having not necessarily gathered.

At a combustion process 4 which bums the powder object 3a generated at the above-mentioned pulverization process at high temperature, the powder object 3a is put into a metal container 5 formed in the shape of a ball or square form, and it is burned for 30 to 50 minutes, preferably for about 40 minutes, at 600 to 1000 degrees, preferably 700 to 900 degrees, with a burner 6. Then it is thermally decomposed.

In addition, the powdery or granular carbon may be added to the metal container 5 and burned, and, in addition to various form and electronic structure based on a combination or π combination which carbon essentially has, the various radical and hydrogen atom which are generated during heat decomposition may exist in the structure.

The numeral 7 shows an emission process which the carbon dioxide generated by combustion of other substances which are adsorbing during combustion of the powder object 3a in the combustion process 4 is emitted in the atmosphere by agitating, and the emission process 7 fails automatically and diffusively to catch the gas which occurs from the substance which is sticking to the graphite silica by combustion in the atmosphere.

The numeral 8 shows a re-combustion process that bums again a powder object 3b that remained after carbon dioxide etc. emitted at the emission process at high temperature. In the re-combustion process 8, the powder object 3b is burned at 600 to 1000 degrees, preferably at 700 to 900 degrees, for 30 to 50 minutes, preferably for about 30 minutes by the burner 6 and bums the adhesion thing. After that, the powdered catalytic stuff 9 as a carbonization silicon whisker that does not oxidize is generable.

The powdered catalytic stuff 9 generated by the above manufacture methods is applicable to the manufacture of the metal composite material, having lightweight, high intensity, the rate of high elasticity, high toughness, and heat resistance, based on metal (for example, aluminum, aluminum alloy, magnesium, magnesium alloy).

It can be used as a mixed material or a main material to the functional ceramics which discover the advanced function, using mechanical, thermal, chemical, optical, electric, and physical, the intelligent ceramics which answer environmental conditions mentally and discover a function, the ceramics for structures which are used as various structure parts, mainly using mechanical, thermal, and chemical character, and the electronic ceramics as various electric device parts using electric-electronic functions (electric insulation, a dielectric, piezoelectric, pyroelectric, semiconductic, magnetism, etc.).

Moreover, the catalytic stuff 9 has the character as a nature material of magnetic carbon.

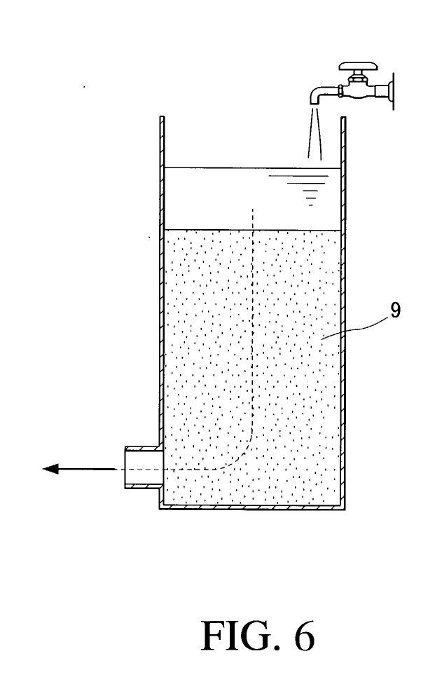

In addition, as illustrated in FIG. 6, it can be used as a filter medium, then the substance contained in water is neutralized, and it becomes high quality water. The pH value of a water examination shows around 7.5. Moreover, minerals contained in tap water, such as a lead, zinc, iron, and copper, are not detected.

Therefore, the growth of vegetables, fruit, etc. is promoted and the amount of harvest also increases by using the filtered water for agricultural work, vegetable cultivation, etc.

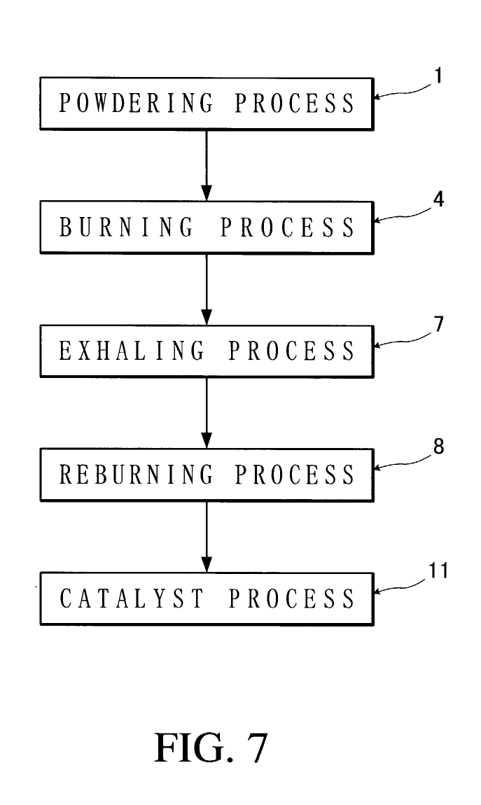

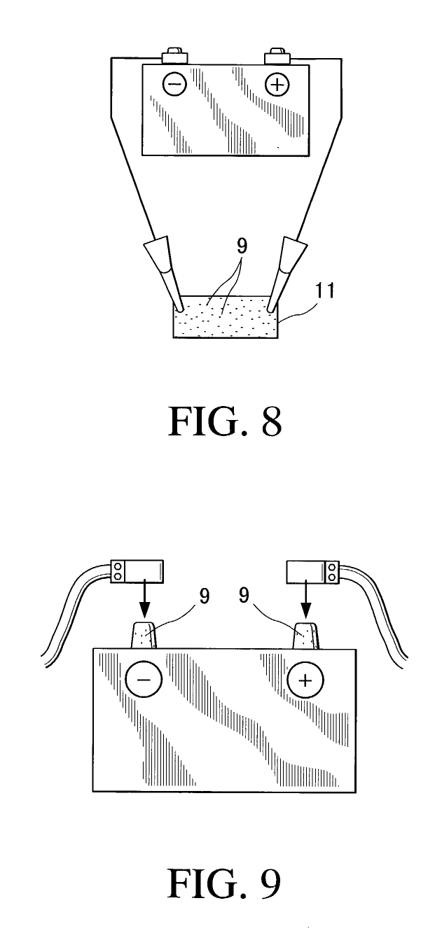

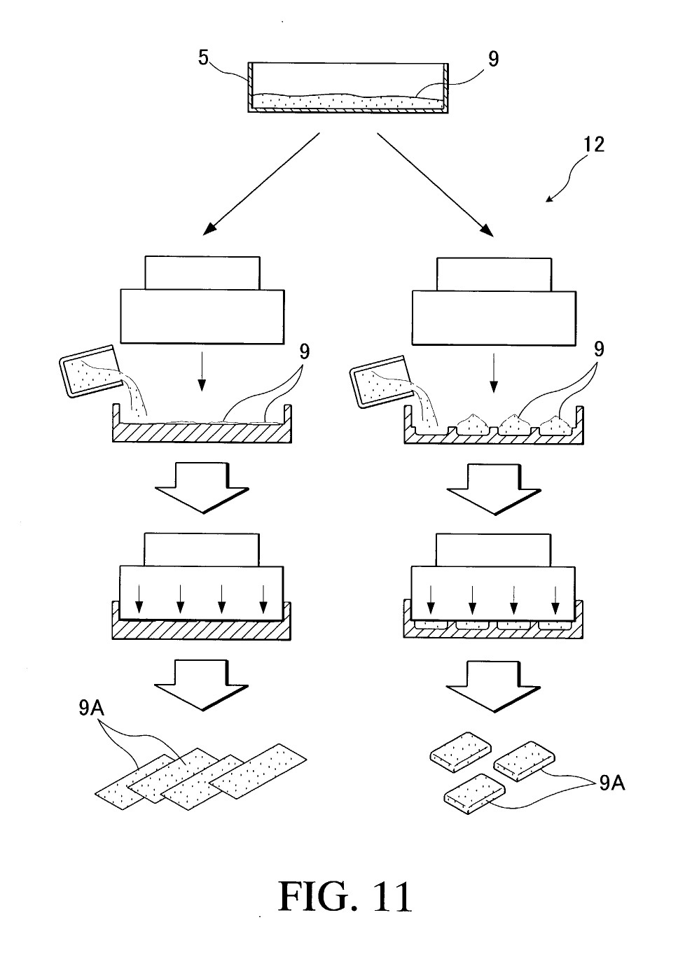

Other embodiments of the present invention will now be described referring to FIGS. 7 to 13. Through the drawings of the embodiments, like components are denoted by like numerals as of the first embodiment and will not be further explained in great detail.

A second embodiment of the present invention is shown in FIGS. 7 to 9. It is distinguished from the first embodiment by the fact that the catalytic stuff 9 and catalytic objects including metal, water and so on, a metal piece 10 in this embodiment is brought about catalysis through current after the re-combustion process, then a catalytic process 11 is operated that performs activation of the atom and molecule which happen by perturbation (electromagnetic field) from the outside is performed. A method for manufacturing a catalytic stuff in this way according to the second embodiment has similar advantages to that according to the first embodiment, and, as illustrated in FIG. 9, when it processes for battery terminals such as a car and if the code in which current flows is made to contact, the quality of current will become high, the influence of an electromagnetic wave will be mitigated, and a battery etc. will demonstrate high quality and get highly efficient power. In addition, the catalytic may be performed using gas.

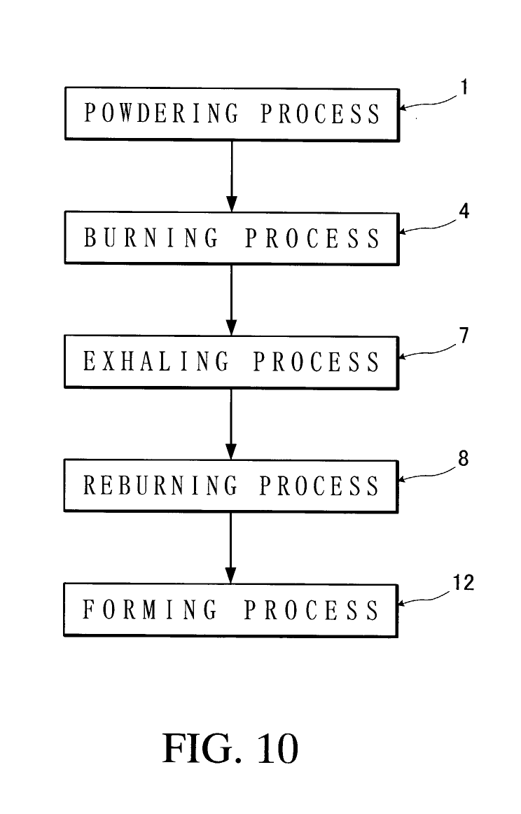

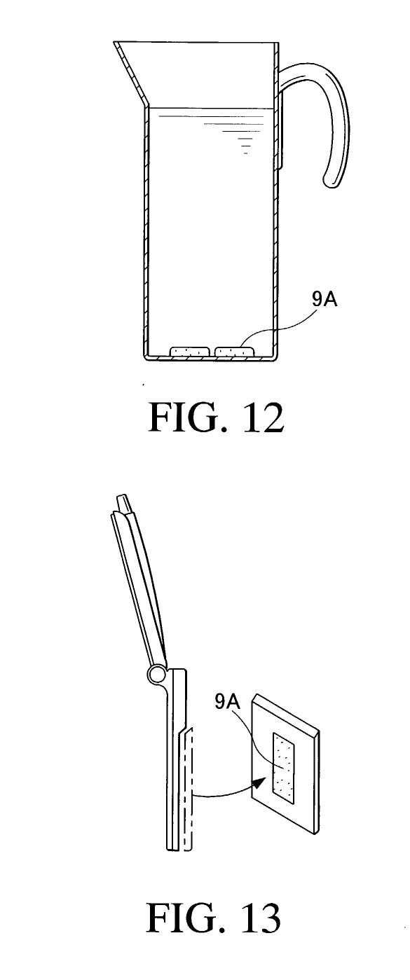

A third embodiment of the present invention is shown in FIGS. 10 to 13. It is distinguished from the first embodiment by the fact that the generated powdered catalytic stuff 9 is formed according to the use purpose solidify, and a catalytic stuff 9A formed in the shape of a solid is formed suitably in a forming process 12. A catalytic stuff 9A according to the third embodiment has similar advantages to that according to the first embodiment, and, as illustrated in FIG. 12, it can and the character of water can change and be improved, putting it in water at a filtration state or spreading state. In addition, if it attaches in the place which an electromagnetic wave generates including a portable telephone, a wall socket, etc. as illustrated in FIG. 13, for example so that the generating of electromagnetic wave can be prevented efficiently, and the body and cell balance can be adjusted efficiently.

Furthermore, although each embodiment differs mainly explained based on the first embodiment, even if it uses the present invention combining the composition used for the form of not only this but each embodiment, the same action effect is acquired.

Moreover, since the catalytic stuff described in each embodiment has a kind of the electromagnetism wave, it rides on the electric wave of a cellular phone etc. having an electric wave and a wave motion and spreads, for example.

As set forth above, the advantages of the invention are as follows:

(1) A method for manufacturing a catalytic stuff includes the grinding the ore containing silica as main component, carbon, iron dioxide, aluminum, magnesium, titanium, sodium, potassium, and moisture; burning the powder object at high temperature, which is generated after grinded the ore; emitting the carbon dioxide generated by combustion and churning of other substances which are sticking to silica during combustion of the powder object; and burning the remained catalytic stuff at high temperature again after carbon dioxide emits at this emission process and manufacturing a catalytic stuff which is used for the mixed material with metal, filter medium of pollution water, propagation material etc. so that the tap water, the polluted water are improved efficient using the generated catalytic stuff, and it can be used broadly as water for home use, water for industrial use, water for agricultural use, and medical treatment, etc.

(2) As discussed above, since the generated catalytic stuff has the ultra-red ray effect etc., the balance of the body and cell can improve remarkably by holding this catalytic stuff.

(3) As discussed above, since the catalytic stuff is generable to powder, it can be easily used as mixed material for metal, main material for metal, etc.

(4) As discussed above, also claims 2 and 3 is acquired with the same action and effect as the above (1) and (2).

What is claimed is:

1. A method for manufacturing a catalytic stuff comprising:
grinding an ore the grinding the ore containing silica as main component, carbon, iron dioxide, aluminum, magnesium, titanium, sodium, potassium, and moisture;
burning a powder object generated after grinded the ore at high temperature;
emitting the carbon dioxide generated by combustion and churning of other substances which are sticking to silica during combustion of the powder object; and
burning the remained catalytic stuff at high temperature again after carbon dioxide emits at this emission process and manufacturing a catalytic stuff which is used as one of a mixed material with metal, filter medium of pollution water, propagation material.

2. A method for manufacturing a catalytic stuff comprising:
grinding the ore the grinding the ore containing silica as main component, carbon, iron dioxide, aluminum, magnesium, titanium, sodium, potassium, and moisture;
burning a powder object generated after grinded the ore at high temperature;
emitting the carbon dioxide generated by combustion and churning of other substances which are sticking to silica during combustion of the powder object;
burning the remained catalytic stuff at high temperature again after carbon dioxide emits at this emission process; and
bringing about catalysis by burning the powder object with catalytic materials including one of metal and water through current etc. and manufacturing a catalytic stuff which includes a revival glow process which generates which is used as one of a mixed material with metal, filter medium of pollution water, propagation material.

3. A catalytic stuff comprising of emitting a gas generated by combustion of an ore containing a silica as main component and so on and being manufactured so as to be used as one of a mixed material with metal, filter medium of pollution water and propagation material.
